(19) United States
(12) Patent Application Publication
(10) Pub. No.: US 2010/0141838 A1
(43) Pub. Date: Jun. 10, 2010

(54) Presentation synchronization system and method

(76) Inventor: Andrew Peter Steggles, Hoboken, NJ (US)

Correspondence Address: W. EDWARD RAMAGE, COMMERCE CENTER SUITE 1000, 211 COMMERCE ST, NASHVILLE, TN, 37201, US

(21) Appl. No.: 12/330,406

(22) Filed: Dec. 8, 2008

(51) Int. Cl. H04N 9/475

(52) U.S. Cl. 348/512; 348/E09.034

(57) ABSTRACT

A system for synchronizing the audio or video and visual components of a presentation through a web-based application. The user listens to an audio or video recording file while viewing a series of visual presentation components, such as individual slides, and clicking on or otherwise indicating when a particular component of the visual presentation should start corresponding with the audio or video recording. The system keeps track of the timing of the user clicks or actions, and saves the presentation as a synchronized audio/video and visual presentation available for viewing and listening.

This application claims priority to Provisional Patent Application No. 61/012,053, entitled “Audio and Visual Web-Based Synchronization Tool,” filed Dec. 7, 2007, and is entitled to that filing date for priority. The complete disclosure, specification, drawings and attachments of Provisional Patent Application No. 61/012,053 are incorporated herein in their entireties by reference.

### FIELD OF INVENTION

This invention relates to a system and method for synchronizing pre-recorded audio and/or video with a visual presentation.

### BACKGROUND OF INVENTION

An events management company typically collects presentations from the speakers or moderators of an event, and often makes them available for download through a website. Event organizers will often arrange to have some or all of the presentations audio or video recorded, as well. As a result, a PowerPoint or other form of visual presentation is available for download or viewing, as is the audio/video recording, but the audio/video and visual presentation often are not synchronized. Accordingly, the user typically does not know which slide or visual the speaker is referring to when listening to the audio/video. This problem is compounded when there are several speakers or moderators which are all recorded in one or more audio/video files, along with one or more visual presentations considered to be part of the same session or presentation.

### BRIEF DESCRIPTION OF THE DRAWINGS

FIG. 1 is a view of an presentation synchronization screen in accordance with one embodiment of the present invention.

FIG. 2 is another view of a presentation synchronization screen in accordance with one embodiment of the present invention.

FIG. 3 is another view of a presentation synchronization screen in accordance with one embodiment of the present invention.

FIG. 4 is another view of a presentation synchronization screen in accordance with another embodiment of the present invention.

### DETAILED DESCRIPTION OF EXEMPLARY EMBODIMENTS

In one exemplary embodiment, the present invention comprises a system for synchronizing audio and/or video recordings with the visual component of a presentation. The system is accessible through the Internet, and may be accessed through a web-browser. The system comprises a computer server with the system application stored thereon on a storage device, such as a hard disk or drive, which is accessed by a user with a computer or similar computing device able to access the Internet and display a webpage. The user accesses the system through a webpage. Access may be controlled, so that the user must log in or be otherwise authenticated as being authorized to access the webpage.

The server also stores the audio/video recordings and visual presentations (e.g., PowerPoint slides, photos, graphs, charts, etc.) for use by the system. These files may be uploaded by the event coordinators, an audiovisual company recording the session, or the like. In one exemplary embodiment, when both visual and audio/video files have been uploaded, the user (e.g., a speaker or moderator) is then contacted, such as by email, and provided a link to the system website. A link may be provided in an email such that clicking the link initiates the synchronization process. The user is authenticated, such as by log in, upon accessing the system website.

Once logged into the system, the user is provided the option to select the visual presentation and the audio/video recording to be synchronized. Audio/video files may be previewed. Access for a particular user may be limited to presentations that that user participated in or presented, and a user may be presented with a default or single set of visual and audio/video files. Certain users, such as administrators or moderators, may have broader access to other presentations.

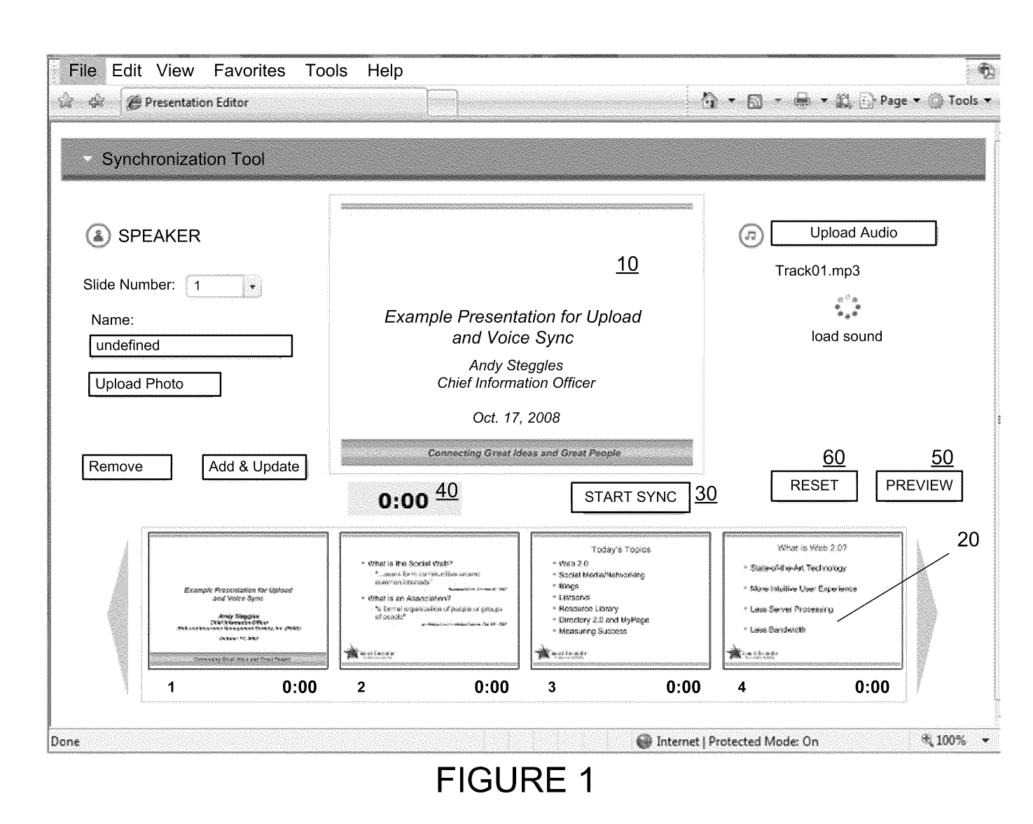

FIG. 1 shows an example of a screen where the user has selected a presentation and a corresponding audio recording. The current slide (in this example, the first slide) of the presentation is shown in the current slide presentation window 10. A number of the adjacent or subsequent slides in the presentation are shown following the current slide in the slide preview window 20. While FIG. 1 shows the current slide and the subsequent three slides being previewed, any number of slides can be previewed.

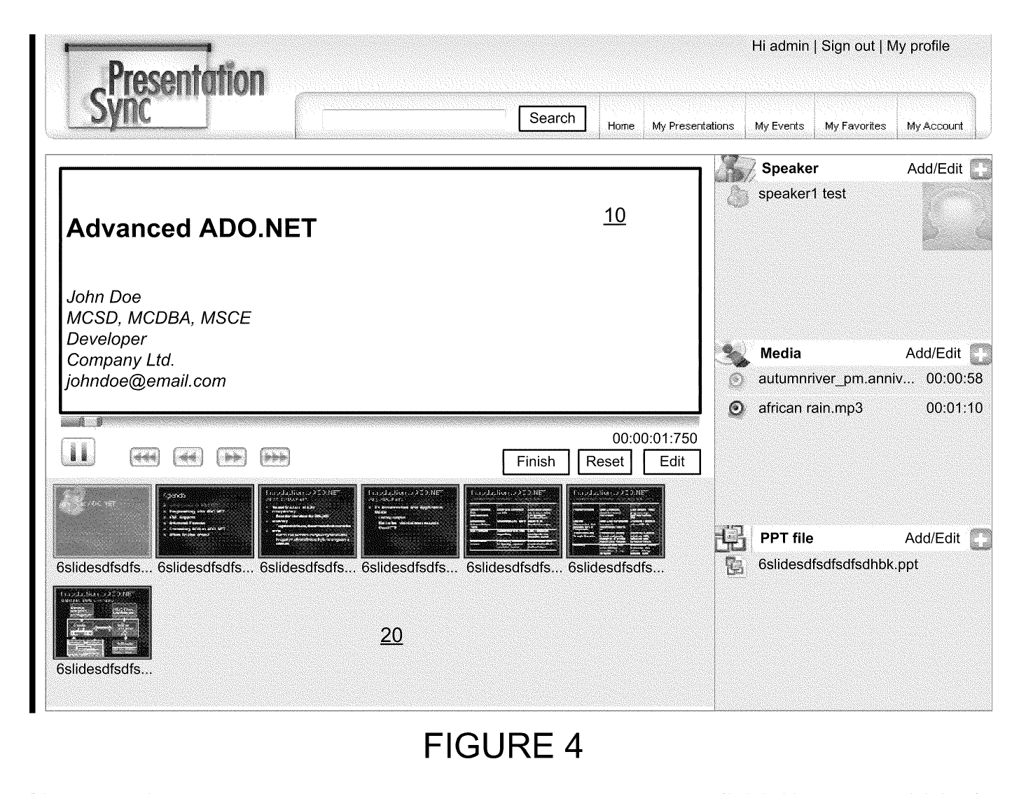

FIG. 4 shows an alternative embodiment of a synchronization screen, with windows to identify, load, and edit speakers, media (such as .mp3 format files), and PowerPoint format files. The current slide presentation window has been shifted, and the slide preview window shows up to 12 slides, with the current slide greyed out.

The user may decide to upload additional speaker information, photographs, or additional slides, or may re-arrange the order of the slides. They also may want to upload additional audio or video files.

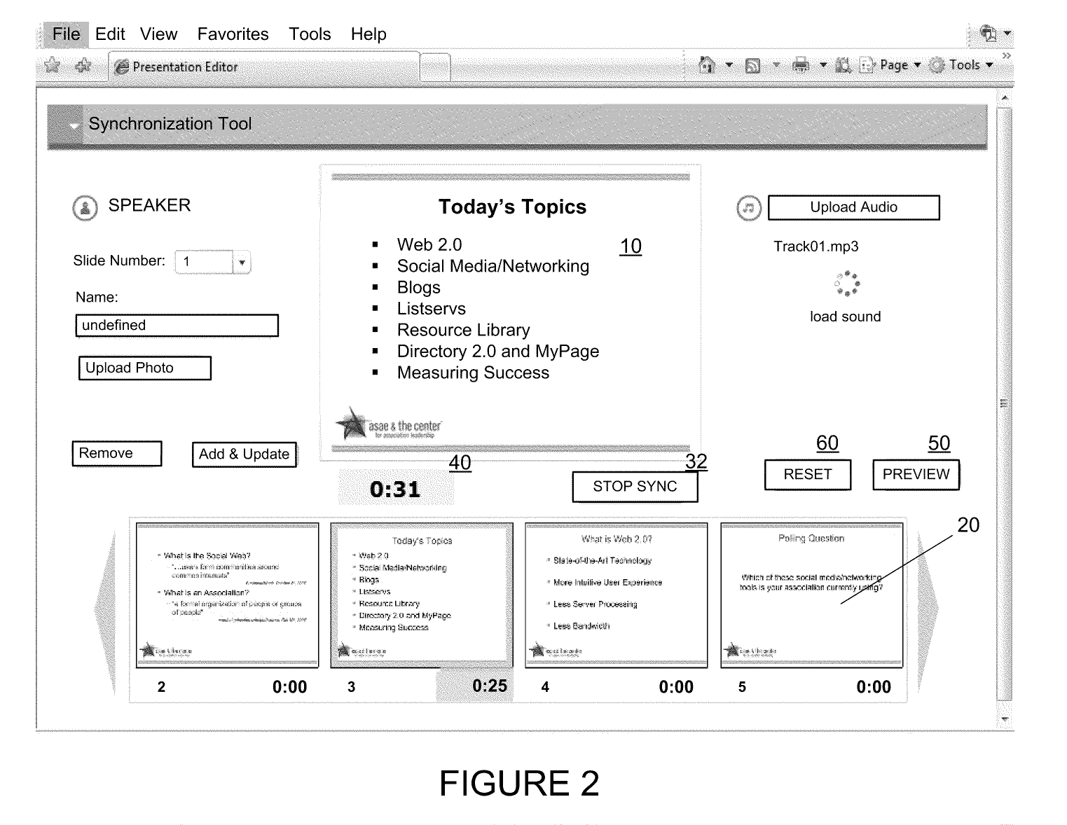

Once all the information about the presentation is up-to-date, the user may begin the synchronization process. To begin the synchronization process, the user clicks on the “Start Sync” or “Play” icon or button 30. This begins playback of the audio or video record, and starts the clock 40, which reflects the passage of time in the audio or video recording. The system will record all of the actions taken by the user. The user listens to the audio or video recording, then clicks on the appropriate slide at the appropriate time. The user also may be presented with a list of speakers/moderators (in a multi-speaker presentation), and may click on or select the appropriate speaker or moderators to indicate who is speaking. To synchronize, the system records the passage of time, and records the point at which the user clicks on either a slide/visual component or on a speaker/moderator, as shown in FIGS. 2 and 4. The system stamps the relative time from the beginning of the audio/video recording and records the respective action(s) by the user.

For example, 9 seconds after clicking the “Start Sync” button, the user may click on slide 2, which puts slide 2 into the current slide presentation window. At 15 seconds, the user clicks on slide 4. At 20 seconds, the user may decide to go back to slide 2 or 3, and so on.

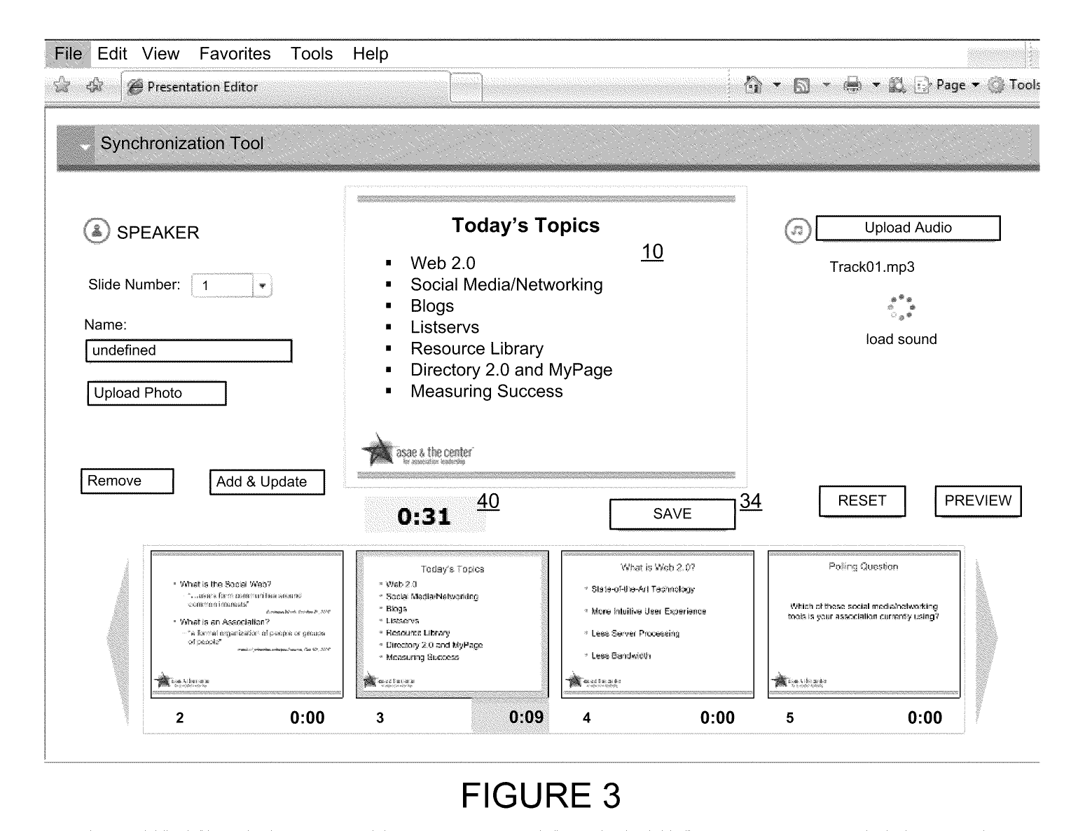

The user may hit the “Stop Sync” button or icon 32 (or the equivalent) to stop the clock and audio/video playback at any time. The user may then save the presentation (as seen in FIG. 3) or continue with synchronization. The user also may choose to preview 50 the presentation, which allows them to view the presentation up to the time it was stopped. The user also may choose to reset 60 the process, which resets the clocks to zero and allows the user to start again at the beginning. Appropriate icons or buttons 50, 60 may be provided for these functions.

When the process is completed, the user may save 34 the synchronized presentation. The presentation may then be downloaded by other viewers and viewed as an audiovisual synchronized presentation.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. A system for synchronization of audio/video recordings and visual presentations, comprising:
a computer server in connection with a network;
one or more electronic storage devices connected to the computer server;
one or more audio or video recording files and one or more visual presentation files stored on the electronic storage devices; and
an application remotely accessible by a user using a computing device with a video monitor or display to synchronize a visual presentation file with a corresponding audio or video recording file.

2. The system of claim 1, wherein the visual presentation file includes one or more photographs or images in electronic form.

3. The system of claim 1, wherein the visual presentation file includes one or more slides in electronic form.

4. The system of claim 1, wherein the user synchronizes the visual presentation and the audio or video files by selecting on a visual presentation component while listening to the audio or video recording file.

5. The system of claim 4, wherein the visual presentation component is correlated to a time period of the audio or video recording.

6. The system of claim 5, wherein the time period starts at the time the visual presentation component is selected and ends at the time another visual presentation component is selected.

7. The system of claim 6, wherein the user listens to the audio or video recording through one or more of a speaker, earphones, or earbuds.

8. The system of claim 1, wherein the network is the Internet.
